(19) United States
(12) Patent Application Publication
(10) Pub. No.: US 2004/0072928 A1
(43) Pub. Date: Apr. 15, 2004

(54) Retarding admixture for concrete

(75) Inventors: Donald R. Lane, Richfield, OH (US); Jose A. Melendez, North Canton, OH (US)

Correspondence Address: James A. Hudak, Esq., Suite #304, 29425 Chagrin Blvd., Cleveland, OH, 44122-4602, US

(73) Assignee: Tomahawk, Inc.

(21) Appl. No.: 10/269,764

(22) Filed: Oct. 15, 2002

(51) Int. Cl. C08J 3/00

(52) U.S. Cl. 524/47

(57) ABSTRACT

An admixture which delays the setting of concrete within a ready-mix truck is disclosed. The admixture is comprised of a mixture of glucono delta lactone and cornstarch and produces exceptional retarding results at a reasonable cost. The corn starch is relatively inexpensive and is used as a filler material to reduce the overall cost of the admixture.

### TECHNICAL FIELD

The present invention relates, in general, to an admixture for retarding the setting of concrete and, more particularly, to a unique, inexpensive concrete retarding admixture that can be utilized within a ready-mix truck allowing concrete to remain within the truck overnight for use on the following day.

### BACKGROUND ART

During the concrete “setting” process, portland cement minerals combine with water through a chemical reaction known as hydration, the products of hydration being known as hydrates. The sequence and rate at which the hydrates form determines the resulting performance characteristic of the concrete including the workability of same, the rate of hardening, the resulting strength of the “set” concrete and the ultimate durability of same. Cement hydration is controlled by the process of hydration product nucleation and nuclei growth. Nuclei are the smallest particle of a reaction product that can be identified as the product and must be formed before growth can occur. The growth of hydration products actually determines the resulting performance characteristics of the concrete.

The cement hydration process can be divided into four distinct time periods: 1) an initial rapid reaction period known as the pre-induction period; 2) an induction period wherein minimal reaction occurs; 3) an initial crystallization or auto-acceleration period during which the concrete begins to set; and 4) a deceleration period during which the concrete increases in strength and the reactions begin to slow, eventually occurring at an imperceptible rate. In the pre-induction period, the reaction between the cement and water occurs rapidly on the surface of the cement grains. The amount of heat released during this period is representative of the degree of cement particle surface activity. Once the surface of the cement particles have undergone an initial reaction, little else occurs until the nuclei that were formed on the cement particle surfaces begin to grow. The initial reaction with water, in essence, passivates the cement, a condition that persists as long as the initial hydrates remain stable. The time during which the cement is passivated is called the induction period of cement hydration. During this period, chemical admixtures can be introduced to obtain a desired effect, after which the concrete can be transported, placed and finished. Admixtures comprising plasticizers or retarders may be added before or after to the concrete to enhance same. For example, the addition of super plasticizers improves slump life. If the plasticizer admixture had been added with the initial mix water, the initial reactions would have partially consumed the plasticizer limiting its effectiveness. However, if the plasticizer is added after the initial reactions have occurred, extended and improved plasticity is achieved. The same is true for retarding admixtures which are specifically designed to be added during the induction period. When the retarding admixture is utilized during this period, the rate at which the cement reacts with the water is decreased preventing the growth of hydrate nuclei. The reaction of the cement with water is not completely stopped by the addition of the admixture—there is a slow increase in the solution concentration of calcium and alkaline ions and hydrate nuclei. When the water solution composition is correct, the hydrate nuclei begin to grow, consuming the dissolved calcium which, in turn, causes further cement hydration and initiates the “setting” of the concrete. Eventually, the process decelerates and the concrete increases in strength and the reactions therein diminish.

Every year millions of cubic yards of concrete in the “plastic” state are returned within the ready-mix truck for disposal purposes, reducing the profits of ready-mix operators and threatening the environment with discarded highly alkaline waste concrete and the water used to rinse the mixing trucks at the end of a work day. A ready-mix truck returning from a job site after unloading its load can still contain about 300 pounds of cement and aggregate, and requires between 150 to 300 gallons of water in order to wash it out and prevent a build-up of hardened concrete within the truck. The concrete can be dumped in a settlement pond or a land fill. With respect to disposing of wash water within the ready-mix truck, since the water is a highly alkaline waste product, it must be disposed of in an environmentally safe manner. All of the foregoing methods of reclamation or disposal are costly and time consuming. If the concrete can be reused as part of a new load, there is no reduction in the profit of the ready-mix operator and the environment is not contaminated by the dumped surplus concrete and the wash water utilized.

It is clearly in the best interest of the ready-mix operator to utilize the total production of concrete in a profitable manner while minimizing any possible damage to the environment by the dumping of surplus concrete and/or the disposing of wash water from the ready-mix truck. Such dumping can be eliminated by adding a retarding admixture to the ready-mix truck permitting the concrete to remain therein over night and be added to another concrete load the next day. The retarding admixture keeps the concrete in a “plastic state”, i.e., it prevents the concrete from setting, thus permitting its reuse. It has been found, however, that such dry admixtures become hard even when packaged in a paper bag which is then sealed within a plastic bag in order to prevent water from contaminating the contents.

In view of the foregoing, it has become desirable to develop a retarding admixture that does not solidify and remains in the powdered state, extends the workability of concrete and delays the setting of same in a controlled manner, is inexpensive to produce and is relatively easy to utilize and overcomes the problems associated with the disposal of surplus concrete and/or wash water used to clean a ready-mix concrete truck.

### SUMMARY OF THE INVENTION

The present invention solves the problems associated with prior art admixtures as well as other problems by providing an admixture which delays the setting of concrete within a ready-mix truck permitting the surplus concrete within the truck to be added to another concrete load on the following day. The admixture, which is comprised of a mixture of glucono delta lactone and cornstarch, produces exceptional retarding results at reasonable costs. Cornstarch is relatively inexpensive and, in this application, is used as a filler material to reduce the overall cost of the admixture. In addition to using a mixture of glucono delta lactone and cornstarch as a retarding admixture in a ready-mix truck, it has been found that this admixture can increase the “board-life” of mortar. Improved “board-life” is desirous in masonry work since it permits the brick mason to leave the mortar on the board for an extended period of time while “laying up” bricks or blocks without experiencing the problem of the mortar starting to prematurely stiffen.

### DESCRIPTION OF THE PREFERRED EMBODIMENT

Retarding admixtures to keep concrete in a “plastic state”, i.e., the admixture prevents the concrete from setting thus permitting the reuse of same on the following day, are available. These retarding admixtures are added to the concrete within a ready-mix truck at the end of a work day and prevent the concrete therein from setting overnight. The concrete can then be used on the following day. It has been found that even when such admixtures are packaged in a paper bag which is then sealed within a plastic bag, the admixture can become very hard. For example, one admixture is comprised of gluconic acid, corn syrup (powder) and calcium lignosufonate (powder). It has been found that when this admixture is freshly made and well blended, it is very pourable and easy to handle. However, after a period of time, even if this admixture is packaged in a paper bag which is then sealed in a plastic bag in order to prevent moisture from entering therein, the material becomes very hard. Analysis of the material revealed that an interactive reaction occurred between the components after they had been packaged. The gluconic acid and the existing sugars contained within the calcium lignosufonate caused hydrolysis to occur resulting in the formation of water which caused the admixture to become hard.

Through numerous tests and experimentation it has been determined that glucono delta lactone is an excellent retarding admixture. Glucono delta lactone is a neutral inner ester of gluconic acid, which has been crystallized through dehydration. It is manufactured by the fermentation of pure D-glucose and has the chemical formula C₆H₁₀O₆. Glucono delta lactone is supplied as a white, crystalline and odorless powder and can be mixed with other dry substances without other undesired reactions. Aqueous solutions of glucono delta lactone resist oxidation and reduction, even at high temperatures and are not corrosive. Glucono delta lactone is easily degradable biologically and consequently provides no waste water problem.

Tests were conducted on separate admixtures comprising 100% glucono delta lactone; 80% glucono delta lactone, 20% cornstarch; 65% glucono delta lactone, 35% cornstarch; and 50% glucono delta lactone, 50% cornstarch. In each case, the admixture sufficiently retarded the setting of the concrete within the ready-mix truck. The cornstarch was added as a “filler material” since glucono delta lactone is rather costly. It was determined that the best results were achieved with 100% glucono delta lactone, however, very acceptable results were also achieved with a mixture of 50% glucono delta lactone and 50% cornstarch. This latter composition of 50% glucono delta lactone and 50% cornstarch is very cost effective since cornstarch is substantially less costly than glucono delta lactone and the substitution of cornstarch as a filler material does not significantly affect the retarding ability of the admixture.

Tests were then conducted with the admixture comprising 50% glucono delta lactone and 50% cornstarch as a “filler material” to determine the proper dosage required to keep the concrete in a “plastic state” while in the ready-mix truck until being reused on the following day. It was found that if the admixture comprising 50% glucono delta lactone and 50% cornstarch was used at a dosage of 0.15% to 0.75% by weight of the concrete within the ready-mix truck, setting of the concrete within the truck was retarded permitting the concrete to be reused on the following day. Thus, the concrete within the ready-mix truck could be sold as part of a new load on the following day and did not have be dumped in a settlement pond or a landfill. In addition, washing of the ready-mix truck was not required, and thus, disposal of the wash water was not a problem. Since the concrete within the ready-mix truck could be reused, the profits of the ready-mix operator were increased. Inasmuch as the ready-mix truck did not need to be washed, the costs associated with washing and disposal of the wash water were not incurred.

In addition to using the aforementioned admixture comprising 50% glucono delta lactone and 50% cornstarch as an admixture to retard the setting of concrete in a ready-mix truck, it has also been found that this admixture can increase the “board-life” of mortar. Improved “board-life” is desirous in masonry work since it permits the brick mason to leave the mortar on the board for an extended period of time while “laying up” bricks or blocks without experiencing the problem of the mortar starting to prematurely stiffen.

Furthermore, it has been found that glucono delta lactone, by itself, as a 15 to 50% liquid solution (by weight) in water also produced excellent results when used as an admixture to retard the setting of concrete in a ready-mix truck. Thus, regardless of whether the admixture is comprised of the combination of glucono delta lactone and cornstarch (both in powder form) or glucono delta lactone (by itself) in a liquid solution, the use of same retards the setting of concrete within the ready-mix truck permitting the concrete to be used on the following day.

Certain modifications and improvements will occur to those skilled in the art upon reading the foregoing. It is understood that all such modifications and improvements have been deleted herein for the sake of conciseness and readability, but are properly within the scope of the following claims.

We claim:

1) A retarding admixture for concrete comprising at least glucono delta lactone.

2) The admixture as defined in claim 1 further including a filler material.

3) The admixture as defined in claim 2 wherein said filler material is cornstarch.

4) The admixture as defined in claim 3 wherein said glucono delta lactone comprises about 50% of the resulting weight of said admixture and said cornstarch comprises about 50% of the resulting weight of said admixture.

5) The admixture as defined in claim 4 wherein the dosage of said admixture is about 0.15% to 0.75% by weight of the cement to which it is to be added.

6) The admixture as defined in claim 1 wherein said glucono delta lactone is a liquid solution of about 15 to 50% by weight of water.
